(19) United States
(12) Patent Application Publication
(10) Pub. No.: US 2012/0050853 A1
(43) Pub. Date: Mar. 1, 2012

(54) PORTABLE FLUORESCENCE MICROSCOPE

(76) Inventors: Andrew Ross Miller, The Woodlands, TX (US); Z. Maria Oden, (US); Robert H. J. Miros, Fairfax, CA (US); Margaret Birmingham Mittan, Piedmont, CA (US); Mark Christopher Pierce, Houston, TX (US); Rebecca Richards-Kortum, Houston, TX (US)

(21) Appl. No.: 13/084,335

(22) Filed: Apr. 11, 2011

Related U.S. Application Data
(60) Provisional application No. 61/322,490, filed on Apr. 9, 2010.

(51) Int. Cl. G02B 21/06; G02B 21/26

(52) U.S. Cl. 359/385

(57) ABSTRACT

A portable microscope is provided comprising a body; a light source comprising a flash light for generating illumination, an objective lens having an optical axis, a stage for holding an object to be observed, and a mirror positioned along the objective optical axis on the other side of the objective lens, wherein the mirror reflects the illumination from the light source along the objective optical axis to an eyepiece. In some embodiments, the light source may be a fluorescent light source.

### CROSS-REFERENCE TO RELATED APPLICATIONS

This application claims priority to U.S. Provisional Patent Application No. 61/322,490, filed Apr. 9, 2010, the entire contents of which is incorporated by reference herein.

### BACKGROUND

The World Health Organization (WHO) estimates that global incidence of tuberculosis (TB) has risen to 9.3 million cases (2008), and malaria remains responsible for up to 2 million deaths annually. Eighty percent of malaria cases and 91% of deaths occur in Africa. Ninety-percent of TB cases and 98% of TB deaths occur in the developing world. In these locations, supply-chain limitations, poor infrastructure, remote healthcare facilities, and limited financial resources complicate diagnostic pathways for patients and limit the effectiveness of organized treatment strategies. Moreover, the WHO recognized that diagnostic pathways requiring patients to travel to a centralized location place financial burdens on the patient and often result in their dropping out of “directly observed treatment strategy” (DOTS) programs before results of TB tests can be communicated to them. The report concluded that an abbreviated diagnostic pathway could lead to more effective treatment. To shorten the time required for patients to receive a TB diagnosis, mobile screening initiatives are being implemented; however, these efforts are currently limited by the size and cost of the key technology required to perform these tests—fluorescence microscopes.

A recent advance in fluorescence microscopy for TB and malaria screening is the Primo Star iLED fluorescence microscope made by Zeiss in partnership with the Foundation for Innovative New Diagnostics (FIND). However, this microscope is not optimized for portability as it is a desktop microscope, requires electricity at least some of the time it is in operation, and is expensive. Nor is this microscope optimized for use in telemedicine. Telemedicine is an application of clinical medicine wherein medical information may be transferred through interactive audiovisual media for the purpose of consulting, and sometimes remote medical procedures or examinations. Telemedicine may be particularly beneficial for people living in the developing world.

Thus, although fluorescence microscopes are generally known, none have been optimized for the developing world by addressing cost, reparability, and portability.

### SUMMARY

The present disclosure generally relates to a portable microscope. More particularly, the present disclosure relates to a portable fluorescence microscope.

In one embodiment, the present disclosure provides a portable microscope comprising a body; a light source comprising a flash light for generating illumination; an objective lens having an optical axis; a stage for holding an object to be observed; and two mirrors positioned along the objective optical axis on the side of the objective lens opposite to the object under observation, wherein the mirrors reflect the light emerging from the object under observation along the objective optical axis to an eyepiece.

In other embodiments, a portable microscope of the present disclosure may further comprise a filter for conditioning the light source, a filter for selectively transmitting light from the fluorescent sample, an assembly for moving the filter in and out of the optical axis, an objective turret for holding objectives and rotating them into position, grooves on the objective turret to demark location, a spring-plunger on a lid of the microscope, two lids on the microscope, a stage that moves the sample up and down, and a cell phone mount that allows for use of a cell phone.

Novel aspects of the present disclosure include, but are not limited to, the design and construction of the microscope, resulting in several advantages over existing microscopy including: lower-cost, easier reparability, multi-functionality of certain components such as the carrying case or the flashlight, greater portability, and easier assembly and disassembly. These advantages will find specific use in point-of-care diagnostic screening initiatives in developing countries but may also be beneficial for use in hospitals for use in emergency kits, veterinarians, educational groups, and medical mission trips.

The features and advantages of the present invention will be apparent to those skilled in the art. While numerous changes may be made by those skilled in the art, such changes are within the spirit of the invention.

### DRAWINGS

Some specific example embodiments of the disclosure may be understood by referring, in part, to the following description and the accompanying drawings.

FIG. 1 is a schematic illustration of a fluorescence microscope of the present disclosure, according to one embodiment.

FIG. 2 is a schematic illustration of a fluorescence microscope of the present disclosure, according to one embodiment.

FIG. 3 is a schematic illustration of a fluorescence microscope of the present disclosure, according to one embodiment.

FIG. 4 is a schematic illustration of a fluorescence microscope of the present disclosure, according to one embodiment.

FIG. 5 is a schematic illustration of a fluorescence microscope of the present disclosure, according to one embodiment.

FIG. 6 is a schematic illustration of a fluorescence microscope of the present disclosure, according to one embodiment.

FIG. 7 is a schematic illustration of a fluorescence microscope of the present disclosure, according to one embodiment.

FIG. 8 is a schematic illustration of a fluorescence microscope of the present disclosure, according to one embodiment.

FIG. 9 is a schematic illustration of a fluorescence microscope of the present disclosure, according to one embodiment.

FIG. 10 is a schematic illustration of a fluorescence microscope of the present disclosure, according to one embodiment.

FIG. 11 is a schematic illustration of a fluorescence microscope of the present disclosure, according to one embodiment.

FIG. 12 is a schematic illustration of a fluorescence microscope of the present disclosure, according to one embodiment.

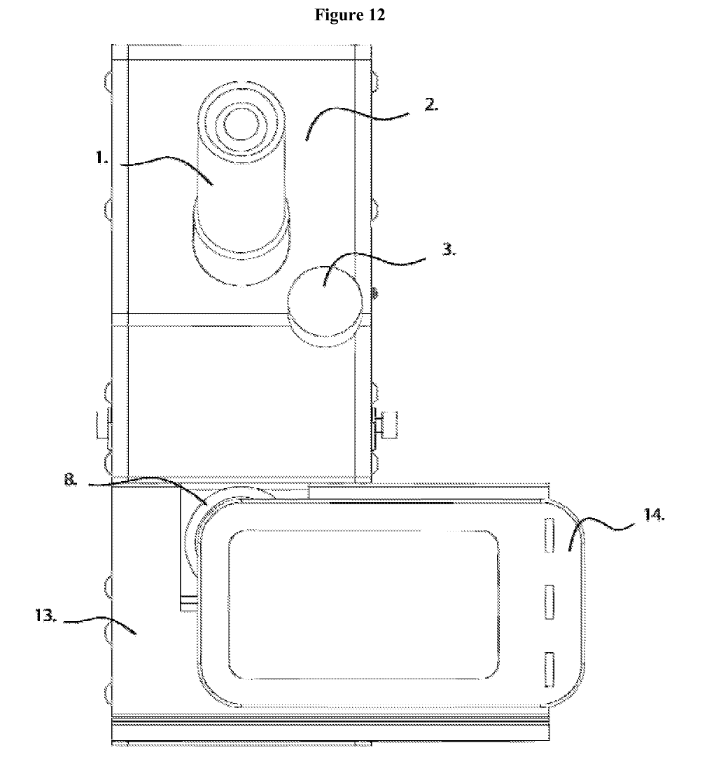

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure generally relates to a portable microscope. More particularly, the present disclosure relates to a portable fluorescence microscope.

In general, a portable microscope of the present disclosure may comprise a body; a light source comprising a flash light for generating illumination; an objective lens having an optical axis; a stage for holding an object to be observed; and two mirrors positioned along the objective optical axis on the other side of the objective lens, wherein the mirrors reflect the illumination from the light source along the objective optical axis to an eyepiece. In certain embodiments, the portable microscope may further comprise an excitation filter, an emission filter, and a mechanism to move the filters into and out of the optical axis.

One of the many potential advantages of a microscope of the present disclosure is that it bypasses many conventions of typical microscope construction, resulting in a design that uses low-cost off-the-shelf parts, such as a flashlight as the light source. These off-the-shelf parts combined with a uniquely simple design make it repairable locally with locally sourced parts. The microscope may be repaired by people with little or no training, e.g. high school students. In addition to its low cost and reparability, a microscope of the present disclosure will allow for a streamlined diagnostic pathway at the point-of-care, and because of its small size and weight, it will enable mobile screening efforts that will bring the added sensitivity and speed of fluorescence microscopy to all patients, even in the most remote locations. In some embodiments, a microscope of the present disclosure is battery-powered and can have up to 1000× magnification. Similarly, in some embodiments, a microscope of the present disclosure can be used for the detection of TB and malaria. In some embodiments, a microscope of the present disclosure may come as a brightfield microscope, a fluorescence microscope, or a microscope enabled to operate in both modes.

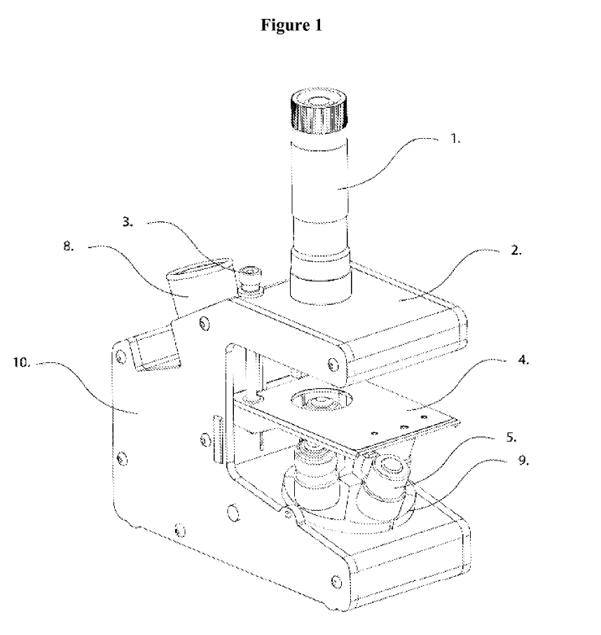

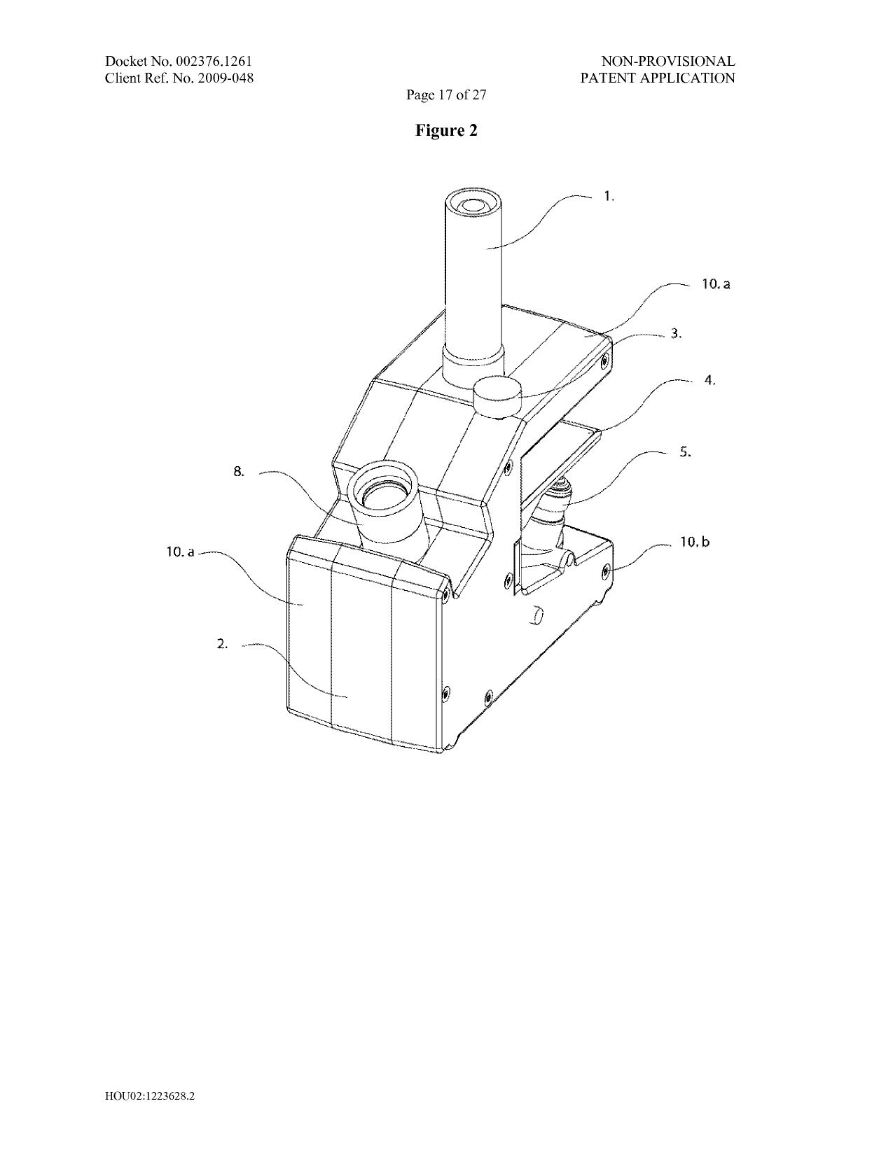

Referring now to embodiments shown in FIG. 1 and FIG. 2, a microscope of the present disclosure may comprise light source 1, main body 2, stage driving mechanism 3, stage assembly 4, one or more objective lenses 5, eyepiece assembly 8, objective turret assembly 9, and one or more lids 10.

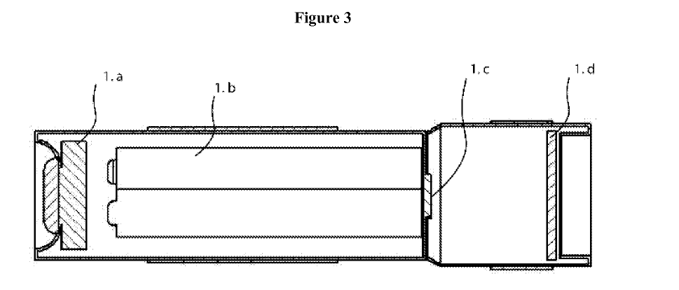

Light source 1 may comprise any type of light source. In certain embodiments, light source 1 may comprise a flashlight assembly. Any flashlight operating in the visible spectrum and near visible spectrum could be used to excite a sample. The wavelengths could range from 200 to 900 nm. In certain embodiments, as shown in FIG. 3, light source 1 may comprise integrated circuit 1.a, one or more batteries 1.b, light emitting diode (LED) 1.c, and optical component 1.d.

In certain embodiments, LED 1.c may comprise a white light LED. In other embodiments, LED 1.c may comprise a narrow spectrum LED whose illumination matches the excitation frequency of the stain to be used. In a preferred embodiment LED 1.c may comprise a Royal Blue LED operating at 460 nm.

In one embodiment, integrated circuit 1.a may be programmed to modulate the pulse width of the LED to match the intensity output of the flashlight to various desired intensities that may correspond to the light transmission properties of the optical system. In some embodiments, integrated circuit 1.a can be used to scale the flashlight intensity without significant power losses to resistance. Further, the flashlight intensity may be scaled to match the amount of light transmitted by each objective wherein a lower power objective corresponds to a lower level of illumination. The illumination settings can be changed by half-depressing the on-off switch on the flashlight. In certain embodiments, a half-click can switch between the light intensities while a full click can turn on and off the flashlight. Pulse width modulation has benefits over using a rheostat (potentiometer) as energy is not lost as heat through a resistor.

In certain embodiments, any suitably sized optical component 1.d may be placed in between the LED 1.c and a cover glass of the flashlight through a simple assembly step (unscrewing the cap of the flashlight and placing the optical component and re screwing the cap). In on embodiment, optical component 1.d may comprise a diffusing lens comprised of randomly textured glass that is placed in both the brightfleld illumination flashlight and the fluorescence illumination flashlight. Further, in certain embodiments, the optical component 1.d may comprise an excitation filter that placed in the flashlight to be used for fluorescence imaging that corresponds to the excitation spectra of the stain to be used. In certain embodiments, multiple optical components can be placed in the illumination flashlight. In a preferred embodiment, a diffusing lens and an excitation filter are placed in the fluorescence illumination flashlight.

One or more batteries 1.b may comprise any type of battery whether rechargeable or disposable. In certain embodiments, batteries 1.b may comprise AA batteries.

In certain embodiments, main body 2 may be made to provide all mounting surfaces for all optical components while also surrounding and protecting the optical components. Main body 2 may be made of any suitably rigid material including glass filled polytetrafluoroethylene, glass-filled polycarbonate, glass-filled Delrin, glass-filled Nylon, Aluminum, Stainless Steel, Polyether Ether Ketone (PEEK), or wood. Various production methods can be used to form main body 2 including die casting, machining, and extrusion. A preferred embodiment uses extrusion.

In general, extrusion is a process used to create objects of a fixed cross-sectional profile where a material is pushed or drawn through a die of the desired cross-section. Extrusion may be continuous (theoretically producing indefinitely long material) or semi-continuous (producing many pieces). The extrusion process can be done with the material hot or cold. Examples of suitable materials for extrusion include, but are not limited to metals, such as aluminum and polymers, such as Nylon-6,6. The extrusion process presents several advantages that are particularly attractive for manufacturing a microscope. First, all optical mounting features can be extruded as features intrinsic to the body of the microscope, which eliminates manufacturing and assembly steps for those components. In one embodiment, a microscope of the present disclosure has the eyepiece assembly 8, light source 1, and reflective optics 6 mounted to the extruded body component. As intrinsic features, the mounting components are at a lower risk of becoming misaligned or broken from the body of the microscope. Second, extrusion process is inexpensive per unit length of extruded material. Third, a plurality of materials is suitable for extrusion.

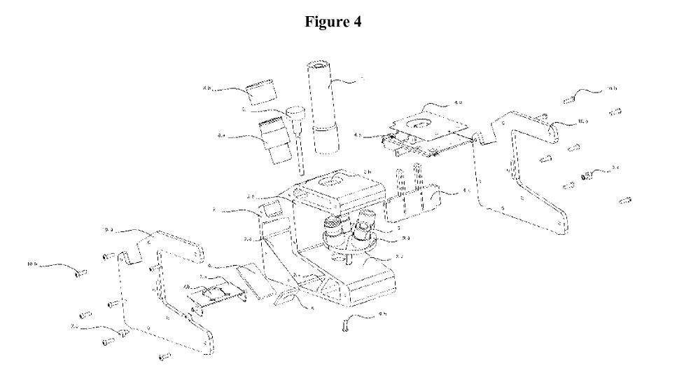

In certain embodiments, as shown in FIG. 4, main body 2 may comprise one or more shelves 2.a, feature 2.b, surface 2.c, shelf 2.d, and shelf 2.e. One or more shelves 2.a may be utilized for mounting reflective optics 6. Feature 2.b may be utilized for mounting light source 1. Surface 2.c may be utilized for mounting objective turret assembly 9. Shelf 2.d may be utilized for mounting eyepiece assembly 8. Shelf 2.e may be utilized for mounting stage assembly 4.

In certain embodiments, the angle of shelves 2.a, 2.d, and 2.e are related and their relationship is defined by Snell's Law. In a preferred embodiment, an angle of 12 degrees between surface 2.c and the bottom of the microscope may be utilized. In certain embodiments, this angle could range from 0 degrees to 45 degrees.

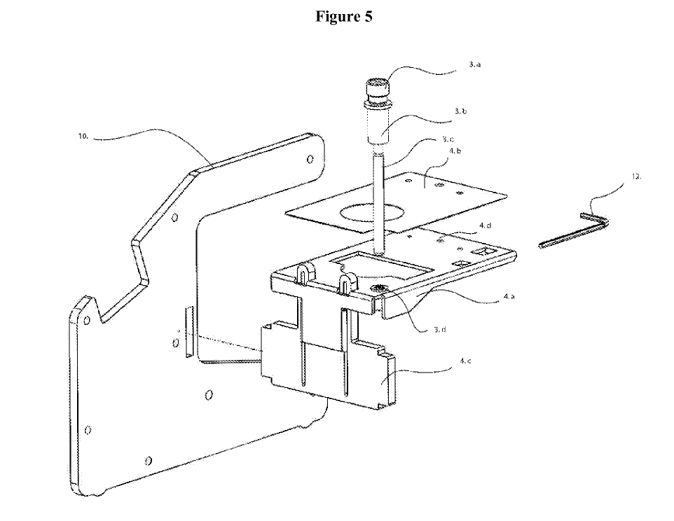

In certain embodiments, as shown in FIG. 5, stage driving mechanism 3 may comprise a focus knob 3.a, bushing 3.b, lead screw 3.c, and threaded bushing 3.d. In certain embodiments, stage driving mechanism 3 is capable of lifting and lowering stage assembly 5. In a preferred embodiment, focus knob 3.a and lead screw 3.c are held captive in main body 2 in bushing 3.b. Stage driving mechanism 3 shall be able to lift and lower the stage.

The resolution (height of stage travel per revolution of the focus knob) of the microscope is defined by the pitch of the lead screw and the width of the focus knob. In a preferred embodiment focus 3.a knob may be 1″ wide and lead screw 3.c is 100 Threads Per Inch (TPI). The threads per inch of lead screw 3.c and width of focus knob 3.a can vary greatly depending on user preferences and magnification. In certain embodiments, focus knob 3.a is interchangeable and can vary in size to allow the user to select a resolution. In other embodiments, a second tool, such as multi-purpose tool 12, can connect to focus knob 3.a and increase the effective width.

In certain embodiments, as shown in FIG. 5, stage assembly 4 may comprise stage 4.a, stage decal 4.b, stage guide 4.c, and one or more mounting features 4.d. Stage 4.a may be constructed out of any rigid material. In certain embodiments, stage 4.a may be constructed out of aluminum. In certain embodiments, stage 4.a may be bent at 90 degrees and have a surface with protrusions that provides a stable surface against main body 2 on one side and stage guide 4.c on the other side. In certain embodiments, the protrusions ride in grooves in stage guide 4.c, giving stage 4.a additional rigidity.

As used herein, the term “stage decal” refers to any suitable thin structure that can provide a suitable surface for a slide to rest on. Stage decal 4.b may be placed on top of stage 4.a to provide a suitably large contact surface for a slide with a minimum height. This may allow a minimum angle of an objective turret 9.a while still allowing the objective turret assembly 9 rotate and clear stage 4.a. In certain embodiments, the hole in stage 4.a is larger than the hole in stage decal 4.b. The use of stage decal 4.b may enable the microscope objective turret to have a shallow angle reducing the overall size of the microscope.

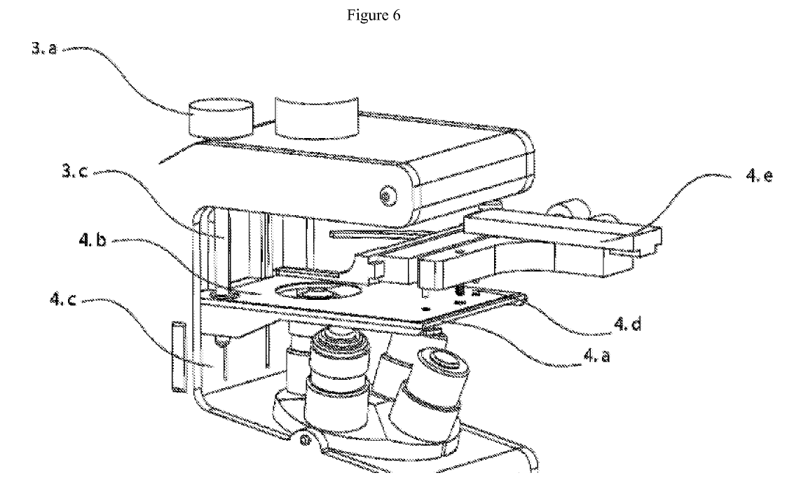

In certain embodiments, mounting features 4.d may be present on stage 4.a to attach X-Y translation stage 4.e, as shown in FIG. 6. In a preferred embodiment two locating pins and one set screw on X-Y translation stage 4.e mate with two locational holes and one threaded hole on stage 4.a. Further, in a preferred embodiment, mounting features exist on the stage so that X-Y translation stage 4.e can be affixed when needed and removed when not in use or for transportation. X-Y translation stage 4.e can be custom or off-the-shelf. In some embodiments, a Labomed stage may be used as X-Y translation stage 4.e.

One or more objective lenses 5 may comprise any type of objective lens. In a preferred embodiment, a DIN standard objective may be used. In one embodiment, the microscope is able to accommodate one to four objectives lenses 5 at a time. In certain embodiments, 185 achromat 4×, 10×, 40×, and 100× objectives (Saintek, China) are used. In a preferred embodiment, the objective turret assembly 9 comprises an objective turret 9.a has four threaded holes for four DIN standard objectives. However, customized objectives could also be mounted.

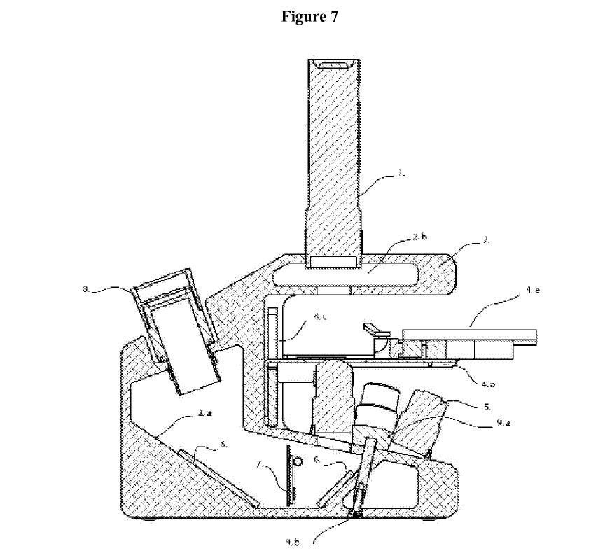

Reflective optics 6 may comprise any a suitably reflective component, such as a prism, a polished metal surface of the main body, or a mirror. In a preferred embodiment, reflective optics 6 may comprise two first surface mirrors that are glued to main body 1, as shown in FIG. 7.

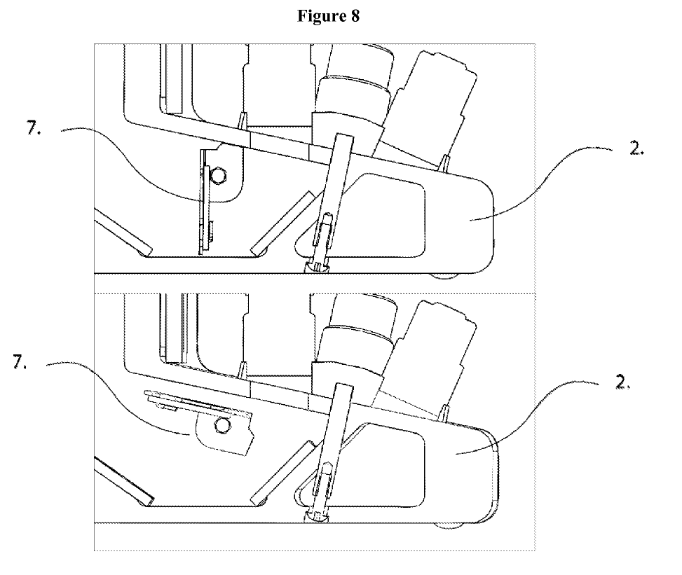

Filter assembly 7 may comprise tray 7.a, filter 7.b, and one or more fasteners 7.c, as shown in FIG. 4. Filter assembly 6 may hold filter 7.b and rotate it or slide it in and out of the optical axis. FIG. 8 depicts a filter 7.b both in and out of the optical axis. In a preferred embodiment, two fasteners 7.c and two wavy washers may be used to rotate tray 7.b. The wavy washers may apply a clamping force between tray 7.a and the one or more lids 10, holding tray 7.a in a desired position. Other embodiments may utilize snap locks to lock tray 7.a in position. Still, in other embodiments, tray 7.a may slide in and out of position and utilize detents to lock it in position.

Any fluorescence filters may be used with the microscope of the present disclosure and should be selected to match the excitation and emission spectra of the fluorescence stain to be used. In a preferred embodiment, the excitation filter and the emission filter correspond to the excitation and emission spectra of Auramine-Orange. In one embodiment, a 450 nm CWL, 40 nm FWHM filter (ThorLabs) is imbedded into the housing of the light source. In one embodiment, a 500 nm longpass filter (Thor Labs) or a custom filter is moved into and out of the optical path with a lever mechanism. In other embodiments, any filter operating in the visible spectrum is envisioned to be used, ranging from 400 to 800 nm.

Eyepiece assembly 8 may comprise an eyepiece 8a and a rubber eye cup 8.b. Similarly, any eyepiece intended for a DIN standard tube length can be used. In a preferred embodiment, a wide field 10× eyepiece (Saintek, China) may used.

Objective turret assembly may comprise one or more objective turrets 9.a. and one or more fasteners 9.b. In certain embodiments, objective turret assembly is held captive in main body 2 with one or more fasteners 9.b. In certain embodiments, the one or more fasteners 9.b. may comprise a screw or a snap rivet. As mentioned above, in a preferred embodiment, the objective turret assembly 9 comprises an objective turret 9.a has four threaded holes for four DIN standard objectives.

One or more lids 10 may comprise any materials. In certain embodiments, the one or more lids 10 may be cut from sheets of material (Delirin®, polypropylene, nylon, plastic, aluminum, and wood). In other embodiments the one or more lids 10 may be injection molded. The one or more lids 10 may comprise a lid surface 10.a and one or more fasteners 10.b to attach the one or more lids 10 to main body 2. The one or more lids 10 can attach to main body 2 with plastic snap features or in any other method of attachment. In some embodiments, the one or more lids 10 also serve to enclose and protect the optical components, as shown in FIG. 2. In other embodiments, a gasket material can be placed in between the one or more lids 10 and the main body 2 to form an hermetic seal.

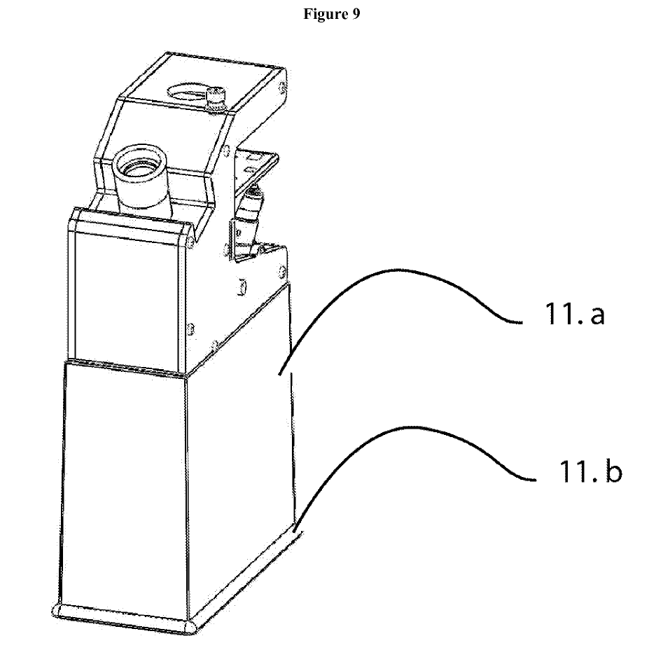

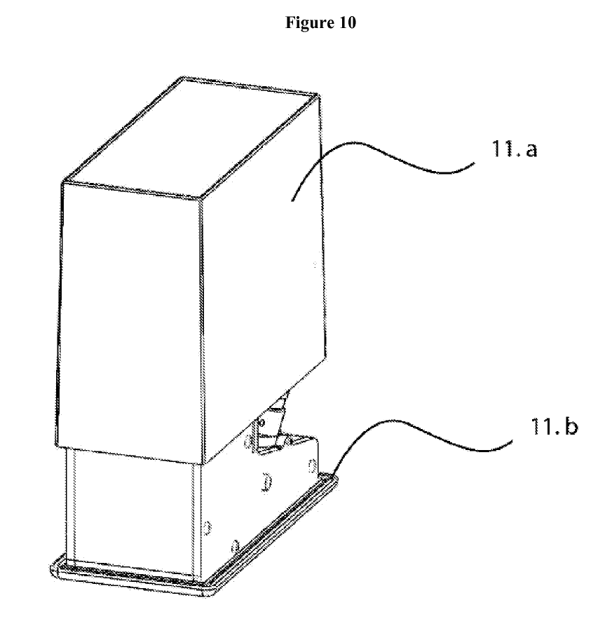

In certain embodiments, as shown in FIGS. 9 and 10, the microscope of the present disclosure may further comprise a multi-purpose case 11. Multi-purpose case 11 may comprise a case body 11.a and a case lid 11.b. Multi-purpose 11 may serve several purposes. First, it may contain and further protect the microscope for travel. Second, when the microscope is in use, multi-purpose case 11 can be used to raise the microscope to a more ergonomic height. Case lid 11.b. may be made of a vibration dampening material (such as a rubber or silicone) that serves as the base when elevating the microscope to a more ergonomic height.

In certain embodiments, as shown in shown in FIG. 5, the microscope may further comprise a multi-purpose tool 12. In some embodiments, the multi-purpose tool 12 may comprise an Allen wrench which may be stored in a custom receptacle under stage 4.a.

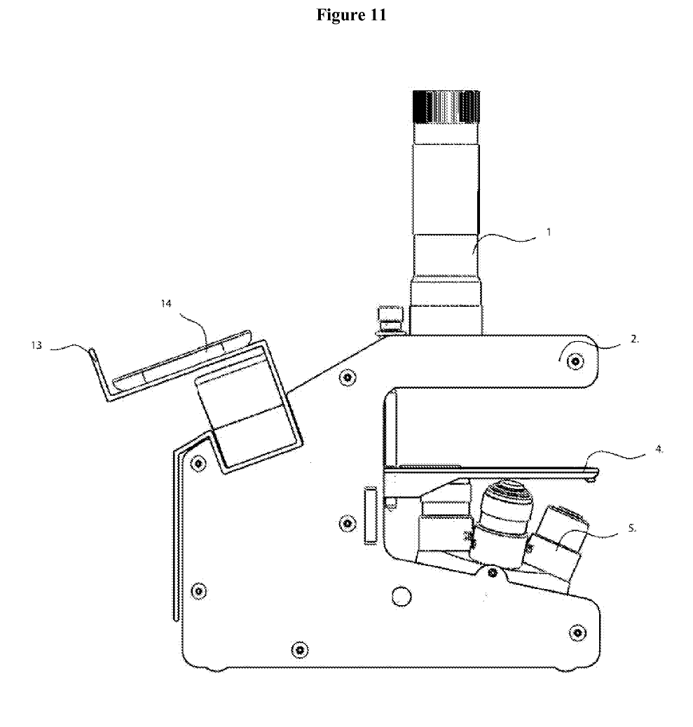

Referring now to FIGS. 10 and 11, in certain embodiments, the microscope may further comprise telemedicine mount 13. In some embodiments, telemedicine mount 13 may be a cell phone mount. In some embodiments the microscope may further comprise cell phone 14. In certain embodiments, a cell phone 14 may be placed onto telemedicine mount 13 where a camera lens of cell phone 14 is placed directly in line with a hole in telemedicine mount 13 and eyepiece 8.a. When cell phone 14 is mounted on telemedicine mount 13 in such a manner, medical information obtained from the microscope may be transferred through interactive audiovisual media.

According to one embodiment, light travels from light source 1 down through a sample into objective lens 5. When operating in bright-field mode, the light from light source 1 then bounces off reflective optics 6, and enters eyepiece 8.a. In a preferred embodiment, a standard tube length of 160 mm is maintained by bouncing light off two mirrors. When operating in fluorescence mode, light travels down from light source 1 through optical component 1.d. down through a sample and then into objective lens 5. The light then bounces off one reflective optic 6 and through filter 7.b before it enters eyepiece 8.a. The filter 7.b may be rotated or slide into position for changing between bright-field and fluorescence modes. The optical component 1.d and filter 7.b may be changed out to accommodate different stains.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A microscope comprising:
a body;
a light source comprising a flash light for generating illumination;
an objective lens having an optical axis;
a stage for holding an object to be observed;
two mirrors or prisms positioned along the objective optical axis on the other side of the objective lens, wherein the mirrors or prisms reflect the illumination from the light source along the objective optical axis to illuminate at least a portion of an object.

2. The microscope of claim 1 wherein the body is extruded in one piece.

3. The microscope of claim 1 wherein the light source is a fluorescent light source.

4. The microscope of claim 1 wherein the light source is a white light LED based flashlight.

5. The microscope of claim 1 wherein the light source comprises both colored and white LEDs.

6. The microscope of claim 1 wherein the light source further comprises an excitation filter.

7. The microscope of claim 1 wherein the microscope further comprises an emission filter.

8. The microscope of claim 1 further comprising a cell phone mounting bracket.

9. The microscope of claim 1 wherein the stage mechanism is comprised of a sheet metal stage that rides in a stage guide and is driven by a lead screw mounted to the microscope body in a captive bushing.

10. The microscope of claim 1 wherein the light source further comprises a light conditioning component such as a diffusing lens or a collimating lens.

11. The microscope of claim 1 wherein the light source comprises a reflective parabola which serves to direct light to the sample.

12. The microscope of claim 1 wherein the microscope further comprises a moveable filter holder.

13. The microscope of claim 1 wherein a carrying case serves also as a stand and a vibration damper.

14. The microscope of claim 1 wherein an x-y translation stage can be affixed and removed.

15. The microscope of claim 1 wherein the microscope stage is suited for well plates.
